(19) United States
(12) Patent Application Publication
(10) Pub. No.: US 2007/0184164 A1
(43) Pub. Date: Aug. 9, 2007

(54) Methods of making and using nutritional compositions

(76) Inventors: Liangli Yu, Ellicot City, MD (US); Jeffrey Moore, Cedar Springs, MI (US)

Correspondence Address: ELMORE PATENT LAW GROUP, PC, 209 MAIN STREET, N. CHELMSFORD, MA, 01863, US

(21) Appl. No.: 11/655,766

(22) Filed: Jan. 19, 2007

Related U.S. Application Data
(60) Provisional application No. 60/743,147, filed on Jan. 19, 2006.

(51) Int. Cl. A23L 1/27

(52) U.S. Cl. 426/540

(57) ABSTRACT

The invention provides premixes in solid particulate form comprising fruit seed or fruit seed fractions for the preparation of food products supplemented with linolenic acid, soluble or insoluble dietary fiber, antioxidants, phytochemicals or any combination thereof, and methods of preparing and using the premixes and supplemented food products of the invention.

### RELATED APPLICATION

This application claims the benefit of U.S. Provisional Application No. 60/743,147, filed on Jan. 19, 2006. The entire teaching of the above application is incorporated herein by reference.

### BACKGROUND OF THE INVENTION

There are those diseases that cannot be cured by medicines once established. Prevention is of paramount importance for such diseases such as cancer and heart disease. Food and supplemented food products may play a critical role to combat these diseases including cancer. It has been widely accepted that eating is not as straightforward as it used to be. Diet can significantly alter the overall health and quality of life. Recently, two-thirds of grocery shoppers reported that their purchase decisions are driven by their desire to either reduce the risk of, or manage, a specific health condition. Novel foods and food supplements rich in health beneficial factors are in high demand to prevent certain diseases, and to promote general human health. It has been shown that antioxidants may benefit general human health and reduce the risk of certain other diseases, such as coronary heart disease, the aging process, and brain disease (Halliwell, B., et al., J. Lab. Clin. Med., 119: 598-620 (1992); Espin, J. C., et al., J. Agric. Food Chem., 48: 648-656 (2000); Chang, S., et al., J. Agri. Food Chem., 48: 147-151 (2000); Merken, H. M., et al., J. Agri. Food Chem., 48: 577-599 (2000); Hoch, G. J., Food Processing, 58(3): 51-52 (1997); Swann, L., Food Process. 58: 54-55 (1997); Chung, H. S., et al., J. Agric. Food Chem., 47: 36-41 (1999). Hundreds of natural and synthetic antioxidants have been evaluated for antioxidative effectiveness. It is widely accepted that antioxidants act as free radical scavengers (quenchers), inhibitors of radical generation, modulators of cellular oxidative status/oxidative stress, or activators of endogenous antioxidative defense enzymes to prevent oxidative damage and consequently benefit human health in general. Recently, consumers favor the approach of prevention by natural antioxidants because of concerns about the long-term safety of synthetic antioxidants including butylated hydroxytoluene (BHT) and butylated hydroxyanisol (BHA). Supplemented food products and nutritional premixes containing novel natural antioxidants including anthocyanin and phenolic compounds with proper physiochemical and organoleptic properties are in high demand for improving disease prevention and health promotion.

α-Linolenic acid (18:3n-3) is an essential co-3 fatty acid that is required nutrient for human beings and has to be obtained through diets including both plant and animal sources. α-Linolenic acid can be converted by elongases and desaturases to other beneficial n-3 fatty acids such as eicosapentanoic acid (EPA) and docosahexanoic acid (DHA), which reported to provide potential health benefits in the risk reduction of heart disease, cancer, hypertension, and autoimmune disorders (Connor, W. F., Am. J. Clin. Nutr., 71: 171S-175S (2000); Hamilton, E. M. N., et al., (5th ed.), West Publishing Co, St. Paul, Minn., p. 125 (1991); Hung, P., et al., Biosci. Biotechnol. Biochem., 64: 2588-2593 (2000); Aronson, W. J, et al., Urology, 58: 283-288 (2001); Iso, H., et al., Stroke 2002, 33, 2086-2093; Tapiero, H., et al., Biomed. Pharmacother., 56: 215-222 (2002). Recent studies also indicate that reducing the.dietary ratio of n-6 to n-3 fatty acids might play a role in decreasing the risk of heart disease and cancer (Aronson, W. J, et al., Urology, 58: 283-288 (2001); Maillard, V., et al., Int. J. Cancer, 98: 78-83 (2002). The current dietary ratio of n-6 to n-3 fatty acids is about 10/1, and the recommended ratio is estimated to be 4/1 (Kris-Etherton, P. M., et al., Am. J. Clin. Nutr., 71: 179S-188S (2000); Schaefer, E. J., Am. J. Clin. Nutr., 75: 191-212 (2002). Supplemented food products and nutritional premixes rich in α-linolenic acid may be used for disease prevention and health promotion.

Dietary fiber including insoluble and soluble fibers has been shown to have health beneficial effects. Dietary fiber may reduce total plasma and LDL cholesterol and reduce the risk of heart disease. In addition, dietary fiber may have laxative effects, reduce the risk of colon cancer, treat gastric hypoacidity, and may be useful in body weight control (Yu, L. ACS Symposium Series, 851: 392-399 (2003). Food products rich in dietary fiber and fiber supplements are commercially available for health promotion and disease prevention.

Fruit seeds are one of the major byproducts from the manufacture of fruit juice. A few studies have detected significant levels of α-linolenic acid and natural antioxidants in fruit seed oils and flours (Oohmah, B. D., et al., Food Chem., 69, 187-193 (2000); Ramadan, M. F., et al., J. Agric. Food Chem., 51: 969-974 (2003); Goffman, F. D., et al., J. Agric. Food Chem., 49: 349-354 (2001); Parry, J. W., et al., J. Food. Sd., 69: 189-193 (2004); Parry, J. W., et al., J. Agri. Food Chem. In press. (2005). For instance, cold-pressed black raspberry seed oil contained 35% of α-linolenic acid and had significant antioxidant activities (Goffinan and Galletti, 2001). Cranberry seed oil was found to be a rich source of essential fatty acids, containing between 35-44% linoleic acid (18:2n-6) and 23-35% α-linolenic acid (Parker, T. D., et al., J. Food Sd., 68: 1240-1243 (2003); Heeg, T., et al., U.S. Pat. No. 6,391,345 (2002), along with significant levels of—sitosterol, and α and γ-tocopherols (Heeg, T., et al., U.S. Pat. No. 6,391,345 (2002). Significant levels of α-linolenic acid were also observed in marionberry, boysenberry, red raspberry, and blueberry seed oils, along with antioxidant activities (Parry, J. W., et al., J. Agric. Food Chem., 53: 566-573 (2005). Cranberry seed oil extract showed significant radical scavenging activities against DPPH and ABTS, protected protein from oxygen radical attack, and suppressed lipid peroxidation in human LDL (Yu, L., et al., Food Chem., 91: 723-729 (2005). In addition, fruit seeds and fractions may contain other nutritional components such as tocopherols and carotenoids, as well as natural colorants, and natural flavor and aroma components (Oohmah, B. D., et al., Food Chem., 69, 187-193 (2000); Ramadan, M. F., et al., J. Agric. Food Chem., 51: 969-974 (2003); Parry, J. W., et al., J. Agric. Food Chem., 53: 566-573 (2005) These components may add value to comestibles and nutritional premixes, while improving safety, quality, and nutritional value of these products. These data suggest that fruit seed oils, flours, and meals might serve as potential dietary sources for natural antioxidants and other beneficial phytochemicals. Replacing other ingredients with fruit seed preparations may reduce the overall cost of the final comestibles while increasing their safety, quality and nutritional values.

Wheat is an important agricultural commodity. Increasing evidence indicates that wheat and wheat fractions may contain significant amounts of natural antioxidants along with tocopherols, carotenoids, and insoluble dietary fibers (Zhou, K., et al., J. Agric. Food Chem., 52: 1118-1123 (2004a); Zhou, K., et al., J. Agric. Food Chem., 52: 6108-6114 (2004b). It is well recognized that these beneficial components are concentrated in wheat bran, thus whole-wheat flour may serve as a dietary source of natural antioxidants and other phytochemicals.

### SUMMARY OF THE INVENTION

The invention provides premixes in solid particulate form comprising fruit seed or fruit seed fractions for the preparation of food products supplemented with linolenic acid, soluble or insoluble dietary fiber, antioxidants, phytochemicals or any combination thereof, and methods of preparing and using the premixes and supplemented food products of the invention.

### DETAILED DESCRIPTION OF THE INVENTION

In accordance with the invention, powdered premixes comprising fruit seed and/or fruit seed fractions for use in the preparation of supplemented food products are provided. The premixes are naturally rich in n-3 essential fatty acids such as α-linolenic acid, antioxidants including anthocyanins; dietary fibers; beneficial phytochemicals such as tocopherols and carotenoids; and combinations thereof and may be used in the preparation of nutritionally supplemented food products to promote health and prevent disease. The premixes of the invention are a cost effective option for providing nutritionally rich foods and food supplements as compared to the more expensive synthetic or naturally derived bioactive additives to achieve comparable nutritional benefits in the promotion of health and prevention of disease. Also, the premixes of the invention naturally impart improved flavor, texture, color and other desirable organoleptic qualities to the food products prepared from the premixes.

The premixes of the invention may be conveniently prepared in a cost effective manner and on a commercial scale (if desired), by utilizing the by-products (fruit seeds) from the fruit food processing industry. The fruit seeds may be derived from a variety of different fruits including, but not limited to: blueberry, boysenberry, marionberry, red raspberry, black raspberry, blackberry strawberry, grape, pawpaw, kiwi, tomato, guava or citrus.

In accordance with the invention, the premixes may be prepared from whole fruit seed in the form of fruit seed meal or fruit seed fraction in the form of fruit seed flour. The meal or flour is dried such that it contains no more than about 20 wt % water and preferably no more than about 12 wt % water and even more preferably no more than about 10 wt % water. The dried meal or flour is further ground under ambient temperature conditions to form fruit seed powder having free-flowing particles in the size range of no more than about 20 mesh, and preferably, the particles sizes are finer than 20 mesh. As used herein, “fruit seed meal” is ground whole fruit seeds and “fruit seed flour” is ground fruit seed after the oil has been extracted. Fruit seed flour may be obtained using a cold press process as is known in the art to extract the oil from seeds yielding the seed flour. The meal or flour may be dried to the desired moisture content using conventional drying techniques suitable for drying food products.

In another embodiment, the fruit seed powder may be prepared by extruding the seed meal or flours with or without additional food ingredients and ground to the desired particles size. In yet another embodiment, the fruit seed powder having the desired particle size may be prepared by spray-drying.

In one embodiment, the fruit seed powders alone may be used directly as a premix in the preparation of supplemented food products. In another embodiment the fruit seed powders are blended with other dry food materials to form a premix for the preparation of supplemented food products. Dry food materials include, for example, dry starch-containing materials, dry protein-containing materials or combinations thereof. Suitable starch-containing materials may be derived from, for example, rice, corn, soybeans, sunflower, canola, wheat, oats, rye, potato, or any combination thereof. Suitable dry protein-containing materials may be derived from for example, meat, milk, fish or any combination thereof. The premixes may optionally also include additional ingredients such as vitamins, mineral fortifiers, salts, colors, flavors, flavor enhancers or sweeteners.

In one embodiment, the premix includes at least about 0.5% α-linolenic acid, antioxidants, phytochemicals or any combination thereof, and at least about 5% soluble and or insoluble fiber.

The premixes of the invention are useful in the preparation of supplemented food products. As used herein, the term “supplemented food product” means a food product suitable and safe for human consumption that contains compounds and compositions that promote good health and/or prevent disease that 1) the food product did not contain prior to supplementation in accordance with the invention and/or 2) the food product contained prior to supplementation but are present in higher amounts after supplementation in accordance with the invention.

Examples of supplemented food products if the invention include beverages, processed meats, frozen desserts, confectionery products, dairy-type products, sauce compositions, and cereal grain products. Beverage products include, for example, smoothies, infant formula, fruit juice beverages, yogurt beverages, coffee beverages, beer, dry beverage mixes, tea fusion beverages, sports beverages, soy liquors, soda, slushes, and frozen beverage mixes. Meat products include, for example, ground chicken products, water-added ham products, bologna, hot dogs, franks, chicken patties, chicken nuggets, beef patties, fish patties, surimi, bacon, luncheon meat, sandwich fillings, deli meats, meat snacks, meatballs, jerky, fajitas, bacon bits, injected meats, and bratwurst. Confectionery products include, for example, chocolates, mousses, chocolate coatings, yogurt coatings, cocoa, frostings, candies, energy bars, and candy bars. Frozen dessert products include, for example, ice cream, malts, shakes, popsicles, sorbets, and frozen pudding products. Dairy-type products include, for example, yogurt, cheese, ice cream, whipped topping, coffee creamer, cream cheese, sour cream, cottage cheese, butter, mayonnaise, milk-based sauces, milk-based salad dressings, and cheese curds. Cereal grain products include, for example, breads, muffins, bagels, pastries, noodles, cookies, pancakes, waffles, biscuits, semolina, chips, tortillas, cakes, crackers, breakfast cereals (including both ready-to-eat and cooked cereals), pretzels, dry bakery mixes, melba toast, breadsticks, croutons, stuffing, energy bars, doughnuts, cakes, popcorn, taco shells, fry coatings, batters, breading, crusts, brownies, pies, puffed soy cakes, crepes, croissants, flour, and polenta. Sauce compositions include salad dressings, nut butter spreads (e.g., peanut butter spreads), marinades, sauces, salsas, jams, cheese sauces, mayonnaise, tartar sauce, soy humus, dips, fruit syrups, and maple syrups. Sauce composition may also include a suspending agent to aid in maintaining the uniformity of the composition. Examples of suitable suspending agents include polysaccharides, such as starch, cellulose (e.g., microcrystalline cellulose) and carrageenan, and polyuronides, such as pectin. Gelatin is another example of a suspending agent which may be used in the beverage compositions as well. Examples of additional supplemented food products prepared using the premixes in accordance with the invention include tofu, formulated soy essence, powdered protein supplements, juice mixable protein supplements, foaming agents, clouding agents, baby foods, meatless balls, meat analogues, egg products (e.g., scrambled eggs), soups, chowders, broth, milk alternatives, soy-milk products, chili, spice mixes, sprinkles, soy whiz, salad topping, edible films, edible sticks, chewing gum, bacon bits, veggie bits, pizza crust barriers, soy pie, no-gas synthetic beans, soy helper, soy cotton candy, fruit bits, pizza rolls, mashed potatoes, spun soy protein fiber, soy roll-ups, extruded snacks, condiments, lotions, fries, gelatin dessert products, vitamin supplements, nutritional bars, dry cake, bread or muffin mixes, and microwavable instant dry mixes. Supplemented food products of the invention may also include pharmaceuticals and nutraceuticals.

The amount of premix used in a supplemented food product can vary greatly depending on the particular food product. In one embodiment, the premix includes at least about 0.4% α-linolenic acid, antioxidants, phytochemicals or any combination thereof, and at least about 4% dietary fiber.

The premixes may be used in any recipe or protocol for the preparation of a supplemented food product. The premix may be added in addition to all of the ingredients called for in a recipe. Alternatively, the premix may replace all or a part of another ingredient in the recipe. For example, if the premix already contains flour, all or a part of the flour called for in the recipe may be replaced with the premix. The premix may be used in dry form or wet form in the recipe or preparation protocol. One skilled in the art of small scale or commercial scale food preparation would be capable of adjusting the recipe or protocol for preparing the supplemented food product in order to maximize the health benefits imparted by the premixes to the final food product.

The premixes of the invention impart a number of desirable characteristics to the final supplemented food product. In addition to the enhanced nutritional value provided by the fruit seed powder present in the premix (e.g. linolenic acid, soluble or insoluble fiber, antioxidants or any combination thereof), the fruit-seed containing premixes provide numerous natural colorant options provided by the various colored fruit seeds thereby eliminating the need to resort to artificial colorants. The fruit seed premixes also naturally contain desirable fruit flavoring as compared to the bland flavoring of materials derived from seed and seed oils such as soybean, canola, sunflower, cottonseed and peanut. Thus the premixes of the invention provide numerous options with regard to natural fruit flavorings eliminating the need to resort to artificial flavorings in the final supplemented food products.

### EXAMPLES

### Example 1

10 gram of fruit seed flour with a moisture content of about 5% in total weight, resulted from cold-pressing process to collect seed oil, was ground at 22° C. for several minutes using a Micro-Mill (Bel-Art Product, Pequannock, N.J. 07440) and passed a 100-mesh sieve. FIG. 1 shows the nutritional premixes made from black raspberry flour.

### Example 2

10 gram of cranberry seeds was ground at 22° C. for several minutes using a Micro-Mill (Bel-Art Product, Pequannock, N.J. 07440) and passed a 40-mesh sieve. The resulting powder was blended with 23 g of 40-mesh whole soft wheat flour, 0.6 g baking powder, 0.35 g salt, and 19 g brown sugar. The resulting blend may be sued as pre-mixes for muffin.

### Example 3

A functional muffin was prepared with the formula: black raspberry seed flour 40 g. whole soft wheat flour 90 g, baking powder 1.2 g, brown sugar 78 g, salt 1.5 g, vegetable oil 50 g, whole egg 25 g, mashed banana 134 g. The dry ingredients were premixed and added in the mixture of egg and oil with mashed banana and sugar. The well-stirred mixture was baked in muffin pan at 350° F. for 25 mm.

### Example 4

A functional cake was prepared with the formula: cranberry seed flour 77 g, whole soft wheat flour 180 g, baking powder 4.8 g, brown sugar 158 g, iodized salt 3 g, corn oil 100 g, whole egg 50 g, mashed banana 268 g. The dry ingredients were premixed and added in the mixture of egg and oil with mashed banana and sugar. The well-stirred mixture was baked at 350° F. for 28 mm.

### Example 5

A functional muffin was prepared with 19 g cranberry seed flour, 53 g whole soft wheat flour, 1.2 g baking powder, 0.75 g salt, 25 g vegetable oil, 12.5 g whole egg, 31 g brown sugar, 16 g dried raisins, 15 g chopped walnuts, and 67 g mashed banana. The dry ingredients were premixed and added in the mixture of egg and oil with mashed banana and sugar. The well-stirred mixture was baked in muffin pan at 350° F. for 25 mm.

### Example 6

A functional muffin was prepared with 19 g grape seed flour, 45 g whole soft wheat flour, 1.2 g baking powder, 0.75 g salt, 25 g vegetable oil, 12.5 g whole egg, 39 g brown sugar, 16 g dried raisins, 14.5 g chopped walnuts, and 67 g mashed banana. The dry ingredients were premixed and added in the mixture of egg and oil with mashed banana and sugar. The well-stirred mixture was baked in muffin pan at 350° F. for 25 mm.

### Example 7

A functional yogurt formulation was prepared with the following formula: black raspberry seed flour 0.5 g, whole milk 192 g, instant non-fat dry milk 8.3 g, plain yogurt 12 g. Ingredients were incubated at 110° F. for 2 hours.

The patent and scientific literature referred to herein establishes the knowledge that is available to those with skill in the art. All United States patents and published or unpublished United States patent applications cited herein are incorporated by reference. All published foreign patents and patent applications cited herein are hereby incorporated by reference. All other published references, documents, manuscripts and scientific literature cited herein are hereby incorporated by reference.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of forming a supplemented food product comprising the steps of:
a) grinding fruit seed or fruit seed fraction having a moisture content of between about 1 and 20% to a particle size of 20 mesh or finer at ambient temperature to form a fruit seed powder;
b) blending the fruit seed powder composition with a dry food material to form a premix; and
c) incorporating the premix of step (b) into the recipe or protocol for preparing a food product to form a supplemented food product, wherein the supplemented food product is supplemented with α-linolenic acid, insoluble or soluble dietary fibers, antioxidants, phytochemicals or any combination thereof.

2. The method of claim 1, wherein the fruit seed or fruit seed flour is derived from blueberry, boysenberry, marionberry, red raspberry, black raspberry, blackberry, strawberry, grape, pawpaw, kiwi, tomato, guava and citra seeds.

3. The method of claim 1, wherein the dry food material is a dry starch-containing material or a dry protein-containing material.

4. The method of claim 3, wherein the dry starch-containing material is derived from rice, corn, soybeans, pulses, quinoa, psyllium, millet, sunflower, canola, wheat, oats, barley, flax, rye, potato, cassava, or any combination thereof.

5. The method of claim 3, wherein the protein-containing material is derived from meat, milk or fish.

6. The method of claim 1, wherein the food product is selected from the group consisting of: beverages, processed meats, frozen desserts, confectionary products, dairy type products, sauce compositions, cereal grain products, nutritional bars, dry cake, bread or muffin mixes, and microwavable instant dry mixes.

7. A dry powder premix comprising ground fruit seed or fruit seed fraction having a dry powder particle size of 20 mesh or finer and a moisture content of between about 1-20% and a dry food material wherein the premix comprises about 0.4% α-linolenic acid, antioxidants, phytochemicals or any combination thereof, and at least about 4% dietary fiber.

8. The premix of claim 7, wherein the fruit seed or fruit seed flour is derived from blueberry, boysenberry, marionberry, red raspberry, black raspberry, blackberry, strawberry, grape, pawpaw, kiwi, tomato, guava and citra seeds.

9. The premix of claim 7, wherein the dry food material is a dry starch-containing material or a dry protein-containing material.

10. The premix of claim 9 wherein the dry starch-containing material is derived from rice, corn, soybeans, sunflower, canola, wheat, oats, rye, potato, cassava, or any combination thereof.

11. The method of claim 7, wherein the protein-containing material is derived from meat, milk or fish.

12. A supplemented food product comprising the premix of claim 7.

13. The supplemented food product of claim 12, wherein the food product is selected from the group consisting of: beverages, processed meats, frozen desserts, confectionary products, dairy type products, sauce compositions and cereal grain products.

14. A method of forming a supplemented food product comprising the steps of:
a) grinding fruit seed or fruit seed fraction having a moisture content of between about 1 and 20% to a particle size of 20 mesh or finer at ambient temperature to form a fruit seed powder premix; and
b) blending the fruit seed powder with a food product to form a supplemented food product, wherein the supplemented food product is supplemented with α-linolenic acid, insoluble or soluble dietary fibers, antioxidants, phytochemicals or any combination thereof.

15. The method of claim 14, wherein the fruit seed or fruit seed flour is derived from blueberry, boysenberry, marionberry, red raspberry black raspberry blackberry strawberry, grape, pawpaw, kiwi, tomato, guava or citra seeds.

16. A dry powder premix comprising ground fruit seed or fruit seed fraction having a dry powder particle size of 20 mesh or finer and a moisture content of between about 1-20% wherein the premix comprises at least about 0.4% α-linolenic acid, antioxidants, phytochemicals or any combination thereof, and at least about 4% dietary fiber.

17. A supplemented food product comprising the premix of claim 16.

18. The supplemented food product of claim 17, wherein the food product is selected from the group consisting of: beverages, processed meats, frozen desserts, confectionary products, dairy type products, sauce compositions and cereal grain products.

19. A supplemented food product produced in accordance with the method of claim 1.

20. A supplemented food product produced in accordance with the method of claim 14.
